(19) United States
(12) Patent Application Publication
(10) Pub. No.: US 2012/0123807 A1
(43) Pub. Date: May 17, 2012

(54) SYSTEMS, METHODS, AND APPARATUS FOR ENTERPRISE BILLING AND ACCOUNTS RECEIVABLE

(75) Inventors: Vincent J. Seaver, Rocky Hill, CT (US); Carolyn D. Jaworski, South Windsor, CT (US); Anthony Snider, Eagan, MN (US); Nicholas Kokotovich, Savage, MN (US); Ann M. McDougall, Wyoming, MN (US); Virnitia J. Holston, Meriden, CT (US)

(73) Assignee: The Travelers Companies, Inc., Hartford, CT (US)

(21) Appl. No.: 13/281,424

(22) Filed: Oct. 25, 2011

Related U.S. Application Data
(60) Provisional application No. 61/406,430, filed on Oct. 25, 2010.
(60) Provisional application No. 61/406,478, filed on Oct. 25, 2010.

(51) Int. Cl. G06Q 40/08

(52) U.S. Cl. 705/4

(57) ABSTRACT

Systems, apparatus, methods and articles of manufacture provide for an integrated operations management system for revenue management and/or billing and accounts receivable (e.g., in an insurance or other financial context). In some embodiments, an operations management system provides for determining a complexity rating for an account (e.g., a loss sensitive insurance account). In some embodiments, the complexity rating may be based on respective answers (e.g., provided by an end user) to one or more survey questions. In some embodiments, the complexity rating may be used for determining a billing priority rating for an account.

### CROSS-REFERENCE TO RELATED APPLICATIONS

The present application claims the benefit of priority of:

U.S. Provisional Patent Application No. 61/406,430, filed on Oct. 25, 2010, and entitled “Enterprise Billing and Accounts Receivable (EBAR)”; and

U.S. Provisional Patent Application No. 61/406,478, filed on Oct. 25, 2010, and entitled “Enterprise Billing and Accounts Receivable (EBAR).”

Each of the applications referenced above is incorporated by reference in the present application in its entirety.

### BACKGROUND

Insurers and other enterprises typically rely on numerous systems, applications, and end users for managing receivables and billing to maintain an inventory of accounts and related information, determine work to be completed, manage progress and completion of invoicing and payment processing, and provide reporting on account and financial data. Revenue management professionals may rely on information from a variety of disparate sources and materials, which may reduce consistency and efficiency due to the vast amount of different information sources available and the time required to cross-reference disparate sources. Yet despite the importance of managing receivables, previous practices have failed to analyze and optimize the workflows and information collected to increase the accuracy, consistency, and reliability of receivable management operations.

### BRIEF DESCRIPTION OF THE DRAWINGS

An understanding of embodiments described in this disclosure and many of the attendant advantages may be readily obtained by reference to the following detailed description when considered with the accompanying drawings, wherein:

FIG. 1A is a diagram of a system according to some embodiments of the present invention;

FIG. 1B is a diagram of a management system according to some embodiments of the present invention;

FIG. 1C is a diagram of an operations management system according to some embodiments of the present invention;

FIG. 2 is a diagram of a computer system according to some embodiments of the present invention;

FIG. 3 is a flowchart of a method according to some embodiments of the present invention;

FIG. 4 is a flowchart of a method according to some embodiments of the present invention;

FIG. 5 is a flowchart of a method according to some embodiments of the present invention;

FIG. 6 depicts an example user interface according to some embodiments of the present invention; and

FIG. 7 is a flowchart of a method according to some embodiments of the present invention.

### DETAILED DESCRIPTION

Applicants have recognized that, in accordance with some embodiments described in this disclosure, account managers, insurance providers, revenue management professionals and others assessing the complexity of a receivable account or other type financial account, may find it beneficial (i) to establish questions useful for assessing the complexity of an account (e.g., for presenting to an end user);(ii) to determine a rating of the complexity of an account (e.g., a relative grade or other rating describing how difficult revenue management has been and/or may be for at least one receivable account); (iii) to provide for more accurate account management by recommending (e.g., to a revenue management professional, to a supervisor of revenue management professionals) one or more actions (e.g., transferring the account to particular professional and/or to a professional having a particular level of experience) based on an assessment of a complexity of a receivable account (e.g., to improve operational efficiency in the account set up, billing, and/or payment processing for the account); and/or (iv) to determine a rating of a billing priority for a receivable account. Some embodiments described in this disclosure provide for the aggregation, analysis and preparation of data (e.g., historical account and/or contact data) for use in providing one or more of the beneficial functions described above.

Applicants have recognized, in accordance with some embodiments described in this disclosure, that some types of users and/or enterprises may find it advantageous to utilize a consolidated environment for managing accounts (e.g., financial accounts, accounts receivable), maintaining an inventory of accounts and related information, and/or managing the progress, transfer, completion and auditing of work on such accounts, in a manner that improves operational efficiencies, operational agility and/or data quality.

Applicants have recognized further, in accordance with some embodiments described in this disclosure, that some types of users and/or enterprises may find it advantageous to determine and utilize one or more account complexity ratings, for example, to transfer and/or balance work among users (e.g., receivable account managers). Applicants have recognized, in accordance with some embodiments described in this disclosure, that some types of users and/or enterprises may find it advantageous to improve operational efficiencies for account managers, including loss sensitive account managers, in the day-to-day handling of various receivable management tasks such as, without limitation, account servicing, open invoices, unapplied suspense and/or billing tasks.

Applicants have recognized, in accordance with some embodiments described in this disclosure, that some types of users and/or enterprises may find it advantageous to have an integrated environment for capturing various types of information such as, without limitation, information about interactions with customers, contact information for internal and/or external sources, information about an inventory of accounts (e.g., by plan year, type, timing for billing), audit trail information (e.g., for historical research) and/or information about marketing and/or management reviews for an account. Applicants have further recognized that it may be advantageous to some types of users to have a centralized source of information that can support a reporting environment accommodating predefined reporting and/or user-defined ad hoc reporting.

Applicants have recognized that it would be desirable, in accordance with some embodiments, to provide a user interface for assessing the complexity of one or more receivable accounts. In one embodiment, a user interface (e.g., provided via an application, such as a web browser, running on or presented via a computing device) allows for receiving information (e.g., from a revenue management professional or other user and/or from a server computer) for determining one or more indications of complexity of an account. Alternatively or in addition, the determined complexity may be received by one computing device from another computing device (e.g., a remote server, a web server) or data storage device and/or may be presented to the user via the interface (e.g., by displaying or otherwise communicating the determined complexity to the user).

Applicants have recognized that it would be desirable, in accordance with some embodiments, to provide a user interface for providing recommendations of one or more actions based on a complexity rating. In one embodiment, a user interface (e.g., provided via an application, such as a web browser, running on or presented via a computing device) allows for receiving information (e.g., from a revenue management supervisor or other user and/or from a server computer) for determining one or more recommended actions (e.g., transferring a more complex receivable account to a more experienced user). Alternatively or in addition, the determined recommendation(s) may be received by one computer device from another computing device or data storage device (e.g., a remote server, a web server) and/or may be presented to the user via the interface (e.g., by displaying or otherwise communicating the determined recommendation(s) to the user). In one example, a report is generated, based on the respective complexity ratings for one or more receivable accounts, which indicates that a particular receivable account should be assigned to a particular end user and/or indicating a particular receivable account should be transferred from a particular end user (e.g., based on the respective complexity rating and the end user's experience level).

Loss sensitive insurance coverage, generally, is one for which the final premium due is dependent on the actual losses during the period the coverage is in effect. Managing risk in this manner may place upper limits on the insured's costs (e.g., $250,000) if its losses are high, but also requires payment of a minimum premium in the event it experiences low losses or is loss-free. Thus, the costs associated with loss sensitive plans tend to vary based on actual loss experience. Accordingly, revenue management for loss sensitive insurance accounts may require more detailed and timely information in order to assess accurately the status and complexity of such accounts. Various embodiments discussed in this disclosure allow for determining a rating or other indication of a complexity and/or billing priority for a receivable account (e.g., a loss sensitive insurance agreement). Such a determination may, for example, enable some insurance carriers to undertake loss sensitive receivable account management more efficiently, which might improve communications with customers and revenue collection, thus resulting in higher customer satisfaction, customer retention and/or reduction of the receivable amount outstanding. In particular, some embodiments allow for the providing of an alert or other notification to a revenue management professional when an account (e.g., associated with a loss sensitive insurance plan) is assessed as being complex and/or when the receivable account is classified as having a high billing priority.

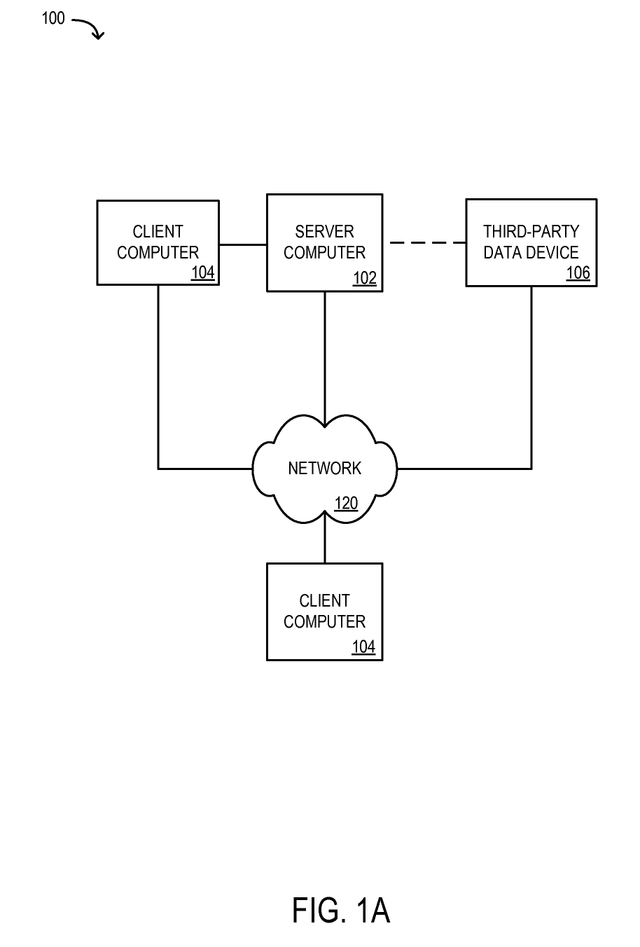

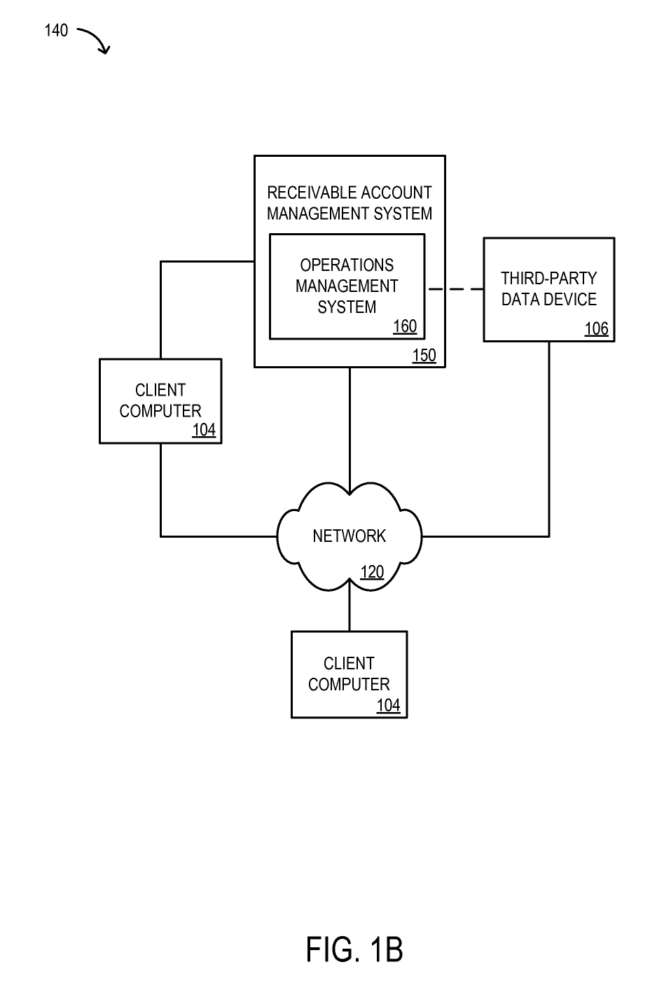

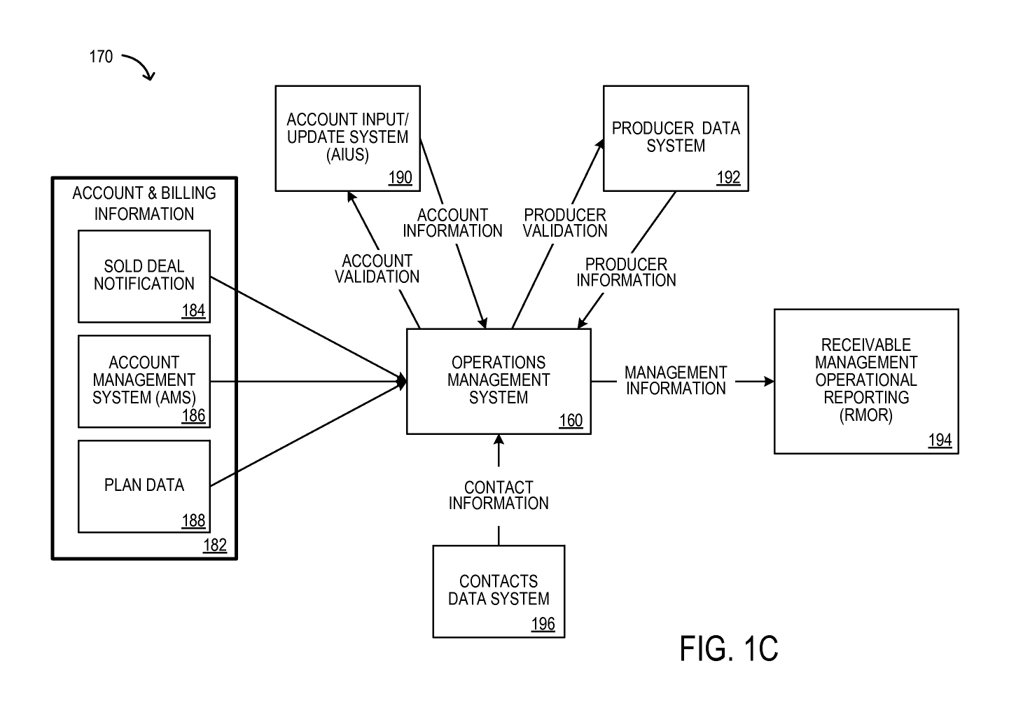

FIG. 1A depicts a block diagram of an example system 100 according to some embodiments. The system 100 may comprise one or more client computers 104 in communication with a controller or server computer 102 via a network 120. Typically a processor (e.g., one or more microprocessors, one or more microcontrollers, one or more digital signal processors) of a client computer 104 or server computer 102 will receive instructions (e.g., from a memory or like device), and execute those instructions, thereby performing one or more processes defined by those instructions. Instructions may be embodied in, e.g., one or more computer programs and/or one or more scripts.

In some embodiments a server computer 102 and/or one or more of the client computers 104 stores and/or has access to data associated with one or more individuals, and useful for managing operations of a revenue management system, including, among other things, determining an indication of the complexity of a receivable account (e.g., with respect to billing) and/or determining at least one recommendation based on the indication of the complexity (e.g., transferring an account to a more experienced revenue management professional and/or updating the billing priority rating for the account).

According to some embodiments, any or all of such data may be stored by or provided via one or more optional third-party data devices 106 of system 100. A third-party data device 106 may comprise, for example, an external hard drive or flash drive connected to a server computer 102, a remote third-party computer system for storing and serving data for use in assessing a complexity of billing a receivable account, or a combination of such remote and local data devices. A third-party entity (e.g., a party other than an owner and/or operator, etc., of the server computer 102, client computer 104 and other than an end-user of any data used in receivable account management) may comprise, without limitation, (i) a third-party vendor collecting data on behalf of the owner, a marketing firm, government agency and/or regulatory body, and/or (ii) a demographic data gathering and/or processing firm. In one embodiment, any raw data, data analysis and/or metrics may be stored on and/or made available (e.g., to an insurer) via the third-party data device 106. In one embodiment, one or more companies and/or end users may subscribe to or otherwise purchase data (e.g., receivable account data) from a third party and receive the data via the third-party data device 106.

In some embodiments, a client computer 104, such as a computer workstation or terminal of a claim professional of an insurance company, is used to execute an operations management application for managing receivable accounts, stored locally on the client computer 104, that accesses information stored on, or provided via, the server computer 102. In another embodiment, the server computer 102 may store some or all of the program instructions for managing receivable accounts, and the client computer 104 may execute the application remotely via the network 120 and/or download from the server computer 102 (e.g., a web server) some or all of the program code for executing one or more of the various functions described in this disclosure.

In one embodiment, a server computer may not be necessary or desirable. For example, some embodiments described in this disclosure may be practiced on one or more devices without a central authority. In such an embodiment, any functions described herein as performed by a server computer and/or data described as stored on a server computer may instead be performed by or stored on one or more such devices. Additional ways of distributing information and program instructions among one or more client computers 104 and/or server computers 102 will be readily understood by one skilled in the art upon contemplation of the present disclosure.

FIG. 1B depicts a block diagram of another example system 140 according to some embodiments. The system 140 may comprise one or more client computers 104 in communication with a receivable accounts management system 150 (e.g., for managing loss sensitive insurance accounts) via a network 120. In one embodiment, a management system 150 may be hosted by, for example, a server computer 102. An operations management system 160 is integrated into the central management system 150, for example, as a module or other functionality accessible through the management system 150. One example of operations management system 160 that may be referred to in this disclosure is an enterprise billing and receivables (EBAR) system for integrating various functions related to management of receivable accounts.

In one embodiment, information about a particular account, e.g., stored by receivable account management system 150, may be provided advantageously to the operations management system 160. For example, without limitation, stored information about insurance contracts, billings, premiums, account validation, installments, exhibits and invoices, contacts associated with the account (e.g., marketers, brokers, receivable account managers, etc.), reporting and/or other information from the account, may be accessible by the operations management system 160 without requiring manual input by a receivable account manager. As discussed above with respect to system 100 of FIG. 1A, in some embodiments one or more third-party data devices 106 may store information used in assessing a complexity of a receivable account with respect to billing (e.g., an indication of how difficult and/or time-consuming it may be to take the account through a billing process).

FIG. 1C depicts a block diagram of another example system 170 according to some embodiments. The system 170 may comprise one or more systems (e.g., sub-systems of a revenue management system 150) in communication with an operations management system 160 (e.g., via an electronic communications network). In some embodiments, the operations management system 160 may be in communication with one or more of: (i) an account and billing information system 182 comprising sold deal notifications 184 (e.g., preliminary communications regarding a deal agreed upon between a broker and an insured), an account management system (AMS) 186 and/or a system for providing insurance plan data 188; (ii) a system for validating and receiving account information (e.g., an account input/update system (AIUS) 190); (iii) a producer data system 192 for validating and receiving information about agents or other types of producers for an insurer; (iv) a receivable management operational reporting system (RMOR) 194 (e.g., for receiving and reporting on management information from the operations management system 160); and (v) a contacts data system 196 for providing information relating to contacts associated with receivable accounts (e.g., email information, telephone information, postal address information, employment information, etc., for contacts internal and/or external to the enterprise).

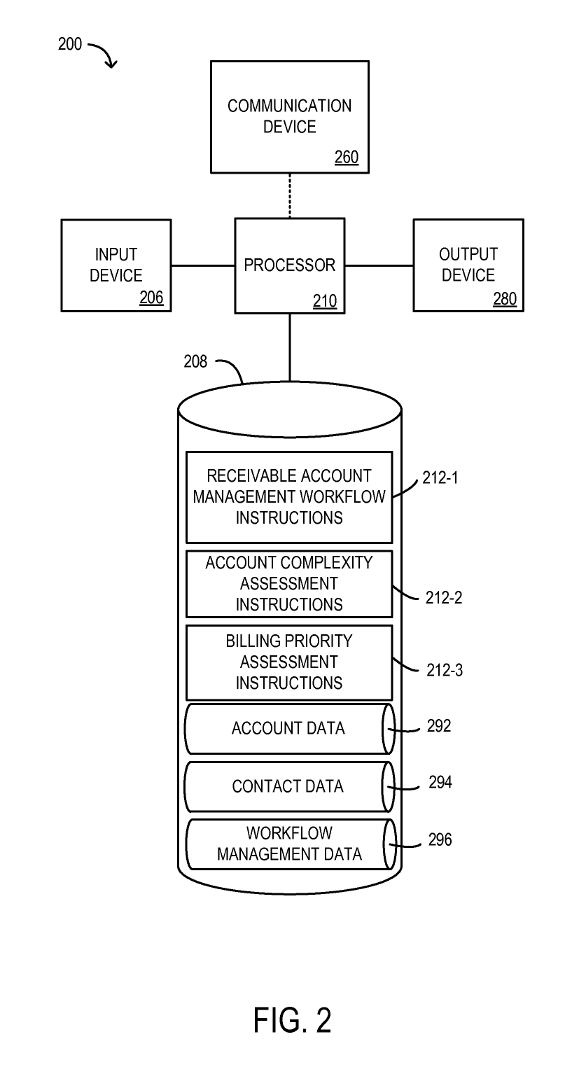

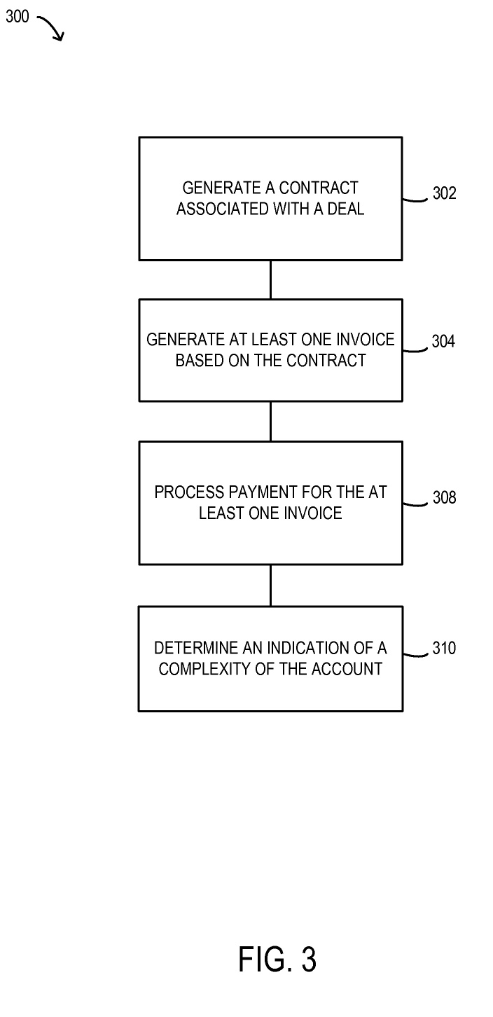

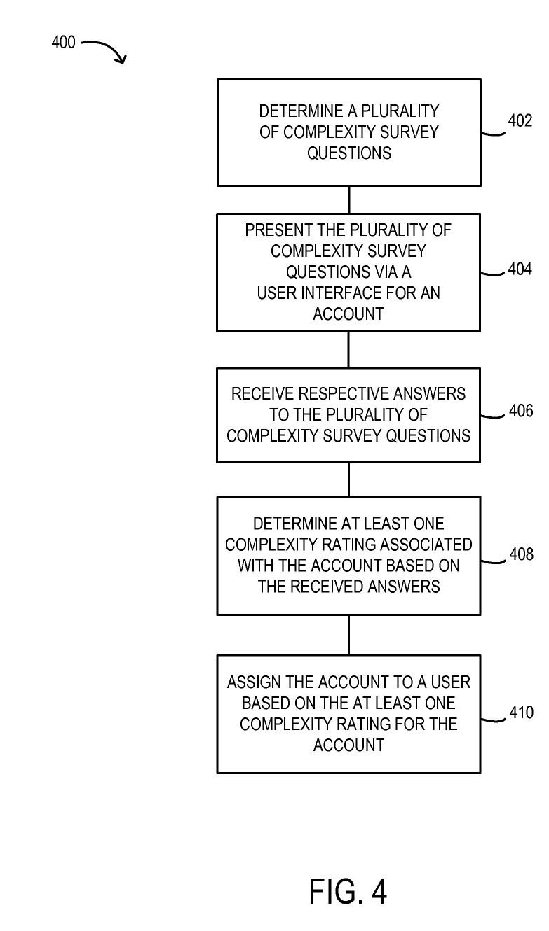

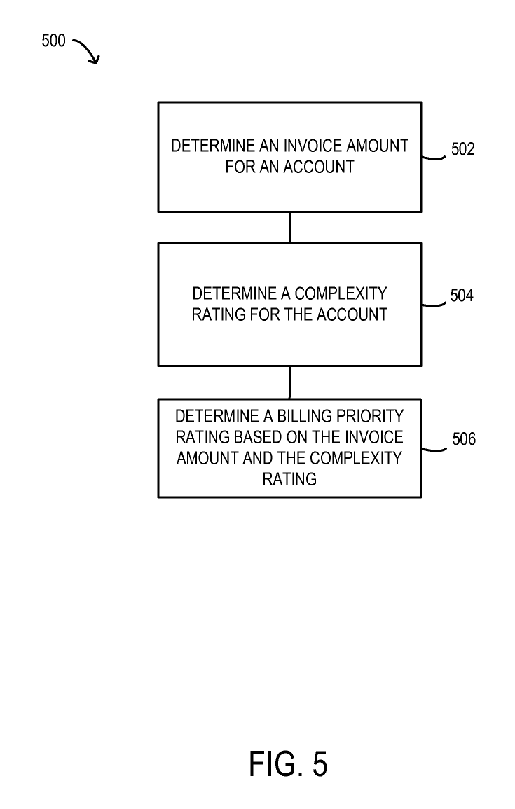

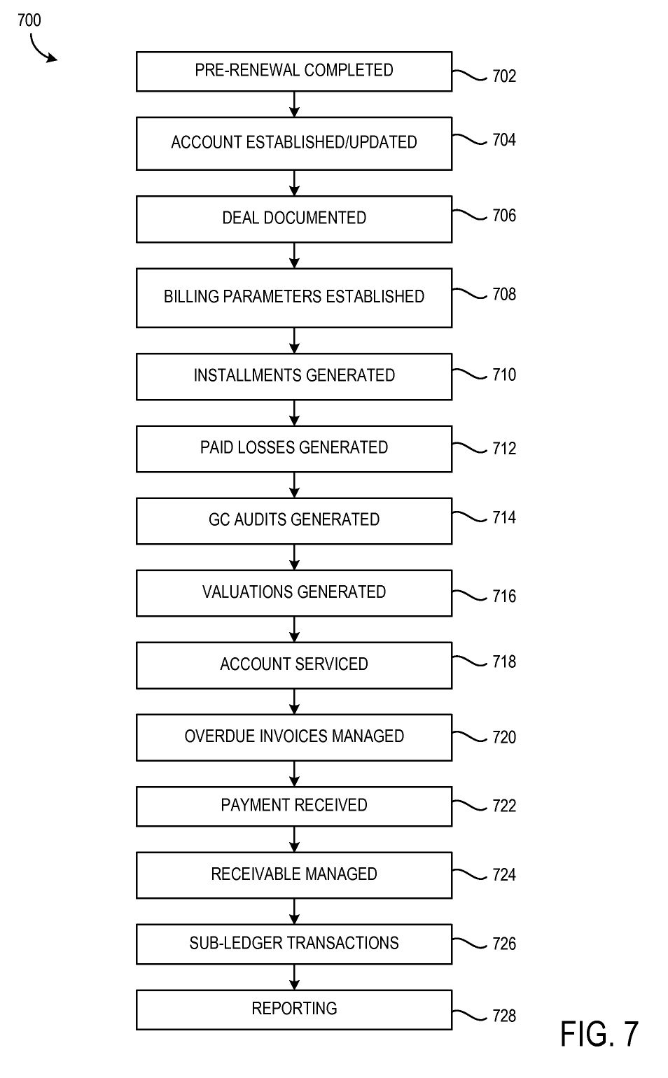

Turning to FIG. 2, a block diagram of an apparatus 200 according to some embodiments is shown. In some embodiments, the apparatus 200 may be similar in configuration and/or functionality to any of the client computers 104, server computers 102, third-party data devices 106, receivable account management system 150 and/or operations management system 160 of FIG. 1A, FIG. 1B and/or FIG. 10. The apparatus 200 may, for example, execute, process, facilitate, and/or otherwise be associated with any of the processes 300, 400, 500 and 700 described in conjunction with FIG. 3, FIG. 4, FIG. 5 and FIG. 7 in this disclosure.

In some embodiments, the apparatus 200 may comprise an input device 206, a memory device 208, a processor 210, a communication device 260, and/or an output device 280. Fewer or more components and/or various configurations of the components 206, 208, 210, 260, 280 may be included in the apparatus 200 without deviating from the scope of embodiments described herein.

According to some embodiments, the processor 210 may be or include any type, quantity, and/or configuration of processor that is or becomes known. The processor 210 may comprise, for example, an Intel® IXP 2800 network processor or an Intel® XEON™ processor coupled with an Intel® E7501 chipset. In some embodiments, the processor 210 may comprise multiple inter-connected processors, microprocessors, and/or micro-engines. According to some embodiments, the processor 210 (and/or the apparatus 200 and/or other components thereof) may be supplied power via a power supply (not shown) such as a battery, an Alternating Current (AC) source, a Direct Current (DC) source, an AC/DC adapter, solar cells, and/or an inertial generator. In the case that the apparatus 200 comprises a server such as a blade server, necessary power may be supplied via a standard AC outlet, power strip, surge protector, and/or Uninterruptible Power Supply (UPS) device.

In some embodiments, the input device 206 and/or the output device 280 are communicatively coupled to the processor 210 (e.g., via wired and/or wireless connections and/or pathways) and they may generally comprise any types or configurations of input and output components and/or devices that are or become known, respectively.

The input device 206 may comprise, for example, a keyboard that allows an operator of the apparatus 200 to interface with the apparatus 200 (e.g., by a receivable account professional) to manage one or more accounts receivable and/or determine an indication of complexity for one or more accounts receivable. In some embodiments, the input device 206 may comprise a sensor configured to provide information, such as encoded account, billing, contact or producer information to the apparatus 200 and/or the processor 210.

The output device 280 may, according to some embodiments, comprise a display screen and/or other practicable output component and/or device. The output device 280 may, for example, provide account information, including complexity information (e.g., via a computer workstation). According to some embodiments, the input device 206 and/or the output device 280 may comprise and/or be embodied in a single device such as a touch-screen monitor.

In some embodiments, the communication device 260 may comprise any type or configuration of communication device that is or becomes known or practicable. The communication device 260 may, for example, comprise a network interface card (NIC), a telephonic device, a cellular network device, a router, a hub, a modem, and/or a communications port or cable. In some embodiments, the communication device 260 may be coupled to provide data to a telecommunications device. The communication device 260 may, for example, comprise a cellular telephone network transmission device that sends signals (e.g., claim information) to a server in communication with a plurality of handheld, mobile and/or telephone devices. According to some embodiments, the communication device 260 may also or alternatively be coupled to the processor 210. In some embodiments, the communication device 260 may comprise an IR, RF, Bluetooth™, and/or Wi-Fi® network device coupled to facilitate communications between the processor 210 and another device (such as one or more client computers, server computers, central controllers and/or third-party data devices).

The memory device 208 may comprise any appropriate information storage device that is or becomes known or available, including, but not limited to, units and/or combinations of magnetic storage devices (e.g., a hard disk drive), optical storage devices, and/or semiconductor memory devices such as Random Access Memory (RAM) devices, Read Only Memory (ROM) devices, Single Data Rate Random Access Memory (SDR-RAM), Double Data Rate Random Access Memory (DDR-RAM), and/or Programmable Read Only Memory (PROM).

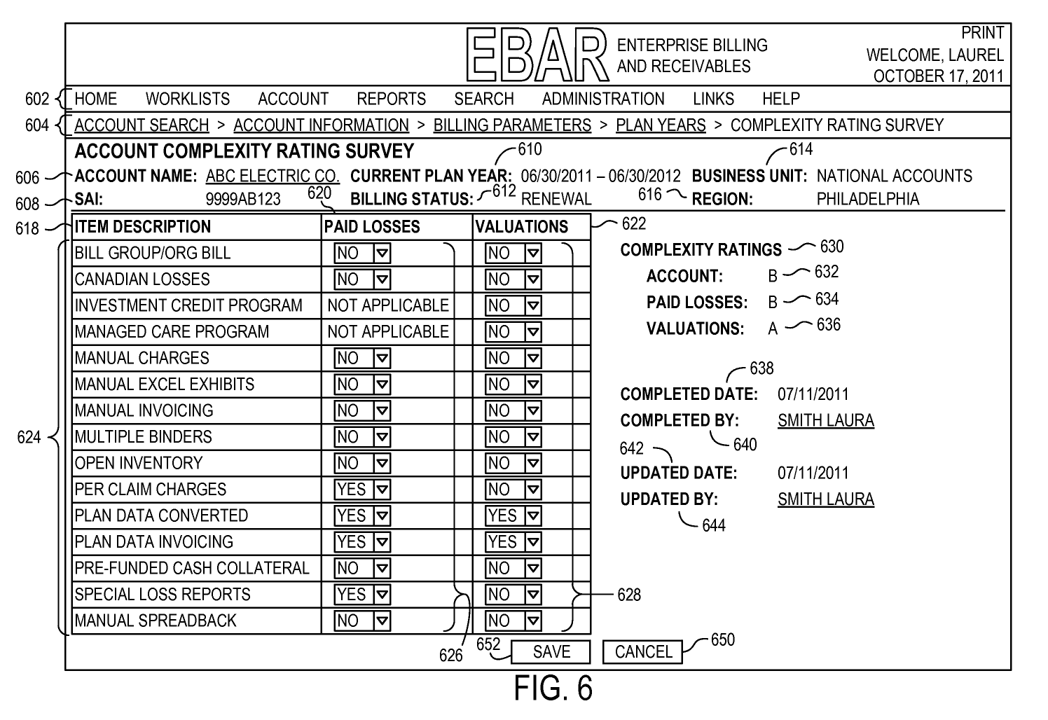

The memory device 208 may, according to some embodiments, store one or more of receivable account management workflow instructions 212-1, account complexity assessment instructions 212-2, billing priority assessment instructions 212-3, account data 292, contact data 294 and/or workflow management data 296. In some embodiments, the instructions 212-1, 212-2 and/or 212-3 may be utilized by the processor 210 to provide output information via the output device 280 and/or the communication device 260 (e.g., via the user interface 600 of FIG. 6).

According to some embodiments, receivable account management workflow instructions 212-1 may be operable to cause the processor 210 to process account data 292, contact data 294 and/or workflow management data 296 as described in this disclosure. Account data 292 received, e.g., via the input device 206 and/or the communication device 260 from one or more devices and/or systems (e.g., as depicted in FIG. 1A, FIG. 1B and/or FIG. 1C) may, for example, be data mined, analyzed, sorted, filtered, decoded, decompressed, ranked, scored, plotted, and/or otherwise processed by the processor 210 in accordance with the instructions of receivable account management workflow instructions 212-1 (e.g., in accordance with the method 300 of FIG. 3). In some embodiments, workflow management data 296 may be updated, for example, to reflect movement of an account through an account set up, paid loss invoicing, valuations invoicing and/or auditing process, such as by adding, deleting and/or completing worklist tasks associated with the account.

According to some embodiments, the account complexity assessment instructions 212-2 may be operable to cause the processor 210 to perform an assessment of the complexity of a receivable account (e.g., for a loss sensitive insurance account) as described herein. Account data 292 and/or workflow management data 294 may be analyzed, for example, to determine a rating, ranking, description or other indication of a complexity of a receivable account (or a defined population of such accounts), such as by deriving, calculating or otherwise generating a complexity rating in accordance with one or more rules, conditions and/or criteria of the account complexity instructions 212-2.

According to some embodiments, it may be required as an item of an associated operations worklist. Various such worklists (e.g., for account set up, paid loss processing, and valuations processing) are described in U.S. Provisional Patent Applications No. 61/406,430 and 61/406,478, whose disclosures are incorporated by reference in this application.

In some embodiments, an account set up worklist requires an assigned receivable account professional to complete a complexity survey form (such as the one depicted in FIG. 6) for any new, renewed and/or updated account. A complexity rating may be required, in some embodiments, for every plan year (or other period) of the associated insurance plan. In some embodiments, a complexity rating associated with a receivable account may reflect only the rating determined based on the most recently completed complexity survey. In other embodiments, the complexity rating may comprise information from earlier surveys and/or from two or more such surveys.

In some embodiments, a complexity survey comprises one or more questions (e.g., presented to a receivable account professional), such as depicted in FIG. 6. The questions may be presented, for example and without limitation, in a YES/NO (or YES/NO/NOT APPLICABLE) format. In one embodiment, the complexity rating is determined based on the number of like answers. For example, a complexity rating may be derived based on a number of “YES” answers, “NO” answers and/or “NOT APPLICABLE” answers. In one example, the total number of complexity survey questions answered affirmatively (e.g., “YES”) may be counted and compared with one or more predetermined count ranges of one or more numbers: 0 “YES” answers may correspond to a rating of “NOT APPLICABLE”; 1-4 “YES” answers may correspond to a rating of “A”; 5-7 “YES” answers may correspond to a rating of “B”; 8-10 “YES” answers may correspond to a rating of “C”; and 11 or more “YES” answers to a survey may correspond to a rating of “D.” Of course, the ranges and corresponding ratings may vary according to the particular implementation desired.

A complexity rating may be determined for a receivable account based on paid loss, valuation and/or one or more other types of billing information associated with a receivable account, and may be an overall complexity rating reflecting, for example, all of the information gathered in a complexity survey. In some embodiments, as depicted in FIG. 6, specific complexity ratings may be determined for an account overall, for paid loss billing and for valuation billing.

In some embodiments, one or more factors or information (e.g., determined based on a survey) may determine a complexity rating, irrespective of other information about the receivable account. In one example, the determination of the complexity rating may be based on a type of insurance plan or program. For instance, if the only program type for a given plan year is “Guaranteed Cost” or some other type that is not Loss Sensitive, the complexity rating may automatically be generated as “NOT APPLICABLE”, “GUARANTEED COST”, or the like, to indicate that the receivable account is not subject to Loss Sensitive complexity considerations.

In another example, if paid loss and/or valuation invoicing for an account is subject to one or more manual processes (e.g., a manual “spreadback”, charge, exhibit, and/or invoicing process), the correspondingly high complexity may be reflected by automatically assigning the indication of the highest complexity rating to the receivable account. Similarly, one or more types of factors may direct the derivation of a rating reflecting the lowest indication of complexity.

According to some embodiments, the billing priority assessment instructions 212-3 may be operable to cause the processor 210 to perform an assessment of the billing priority of a receivable account. Account data 292 and/or workflow management data 294 may be analyzed, for example, to determine a rating, ranking, description or other indication of a billing priority of a receivable account (or a defined population of such accounts), such as by deriving, calculating or otherwise generating a billing priority rating based on one or more of: (i) a complexity rating associated with the receivable account and/or (ii) one or more rules, conditions and/or criteria of the billing priority assessment instructions 212-3. In some embodiments, a determined billing priority indication may be used, for example, in prioritizing one or more workflow actions (e.g., above actions for accounts having relatively lower priorities).

In some embodiments, an operations management system 160 performs a calculation, periodically (e.g., monthly), for each receivable account using respective average invoice amounts and complexity rating and assigns billing priority ratings based on the calculation. Such ratings may be displayed via a user interface for use in prioritizing workloads. Information about an account (e.g., an account status and/or type) may be considered in deciding whether to perform a billing priority calculation.

If an account qualifies for a billing priority calculation, for paid loss worklist items, in one example, the operations management system 160 calculates an average debit net invoice amount for any open or paid invoices for a given period (e.g., twelve months). In another example, for valuation worklist items, the operations management system 160 calculates an average debit net invoice amount for open and paid invoices for a given period (e.g., thirty-six months). In either case, if the average invoice amount is not less than a predetermined threshold (e.g., $1,000), then the system determines the account's billing complexity rating and derives a billing priority rating based on the complexity rating and predetermined invoice amount thresholds. In one example, a complexity rating of “C” or “D” corresponds to a billing priority rating of “Medium” if the invoice amount is between $1,000 and $100,000; a billing priority rating of “High” if the invoice amount is greater than $500,000. In this way, prioritization for worklist items may be determined based on the relative complexity to bill the account and on the relative amount anticipated to be received from billing.

Account data 292, contact data 294 and/or workflow management data 296 may be analyzed, in accordance with one or more embodiments, to determine at least one action that may be recommended (e.g., to a receivable account professional via a user interface and/or report) as potentially useful in improving the efficiency of managing workflow related to one or more receivable accounts. In one embodiment, the at least one recommended action may comprise assigning one or more receivable accounts to a particular receivable account professional, transferring one or more receivable accounts from a particular receivable account professional, assessing a billing priority for one or more receivable accounts and/or updating a billing priority for one or more receivable accounts.

Indications of billing complexity and/or billing priority associated with a receivable account may be stored, for instance, in account data 292 and/or workflow management data 296.

In some embodiments, the apparatus 200 may function as a computer terminal and/or server of an insurance provider. In some embodiments, the apparatus 200 may comprise a web server and/or other portal (e.g., an interactive voice response unit (IVRU)) that provides account data 292, contact data 294 and/or workflow management data 296 to users, consumers and/or corporations.

Any or all of the exemplary instructions and data types described herein and other practicable types of data may be stored in any number, type, and/or configuration of memory devices that is or becomes known. The memory device 208 may, for example, comprise one or more data tables or files, databases, table spaces, registers, and/or other storage structures. In some embodiments, multiple databases and/or storage structures (and/or multiple memory devices 208) may be utilized to store information associated with the apparatus 200. According to some embodiments, the memory device 208 may be incorporated into and/or otherwise coupled to the apparatus 200 (e.g., as shown) or may simply be accessible to the apparatus 200 (e.g., externally located and/or situated).

Referring now to FIG. 3, a flow diagram of a method 300 according to some embodiments is shown. The method 300 may, for example, a workflow (or part of a workflow) be performed by or on behalf of an insurer and/or a receivable account professional (e.g., a receivable account manager (RAM)) or other user, for example in managing a receivable account. It should be noted that although some of the steps of method 300 may be described herein as being performed by a client computer while other steps are described herein as being performed by another computing device, any and all of the steps may be performed by a single computing device, which may be a client computer, server computer, third-party data device or another computing device. Further, any steps described herein as being performed by a particular computing device may be performed by a human or another computing device as appropriate.

According to some embodiments, the method 300 may comprise generating a contract associated with a deal (e.g., an insurance arrangement), at 302. In one embodiment, the contract comprises an agreement letter defining the respective obligations of an insurance company and an insured to whom it is providing insurance coverage. The contract defines, for example, the charges, charge basis, rates, etc., for an insurance plan. In some embodiments, the generating of the contract may be preceded or prompted by a notification of a “sold deal” or other preliminary notification that an insurance deal is being sold (e.g., by an agent or marketer) to the insured.

In some embodiments a receivable account manager or other user may use the contract to set up billing for the account. For example, a RAM may establish the account in a billing system. Once a contract and indication of the installments to be billed to the insured during a plan year have been received by the RAM, the account can be established in one or more systems, as desirable, including an operations management system for a revenue management system. In one example, a RAM begins with an account setup confirmation, which is a communication tool between the account manager for the account and the RAM to ensure that they both interpret the billing parameters for the account the same way. The RAM then sets up installment billing for the account, as well as the billing of losses and claim handling, as provided for in the contract (e.g., an agreement letter).

According to some embodiments, the method 300 may comprise generating at least one invoice based on the contract, at step 304. In one embodiment, invoices and supporting exhibits may be generated automatically based on the frequency agreed upon in the contract. For example, installment and loss bills may be sent on a monthly basis, while valuation bills may be sent annually. In some embodiments, a RAM may make service calls to the insureds and/or brokers, e.g., to verify receipt of a bill and/or to see if they have any questions or concerns. If the bill is not paid by the due date, the RAM may follow up with the insured and/or broker in accordance with an escalation process.

According to some embodiments, the method 300 may comprise processing payment for the at least one invoice, at step 306. According to some embodiments, this may comprise making cash applications, disbursements, waivers or deferrals, check requests and/or market transfers. In one example, when payments are received via one or more of various markets, a RAM applies the monies received to the appropriate invoices. In one embodiment, a RAM may initiate a market transfer if monies are put into the incorrect market, for example. In some embodiments, if commission is due to the broker or the insured is due a credit, the RAM may use a check request process to disburse the money to the proper party.

According to some embodiments, the method 300 may comprise determining an indication of a complexity of the account, at 310. In one embodiment, the indication of the complexity may comprise an indication of the complexity of managing the billing for the account. Various ways of determining recommendation actions and various types of recommended actions are discussed in this disclosure, and others will be apparent to those skilled in the art upon contemplation of this disclosure. In some embodiments, the determined complexity may be communicated to a client computer, server computer, third-party data device and/or to a revenue management professional or other user (e.g., represented on a display device of a computer). Determining the indication of the complexity of the account may take place, in accordance with various embodiments, with the set up of the account, or at any time after the set up of the account. In some embodiments, the complexity is determined periodically, such as on renewal and/or for each plan year.

Referring now to FIG. 4, a flow diagram of a method 400 according to some embodiments is shown. The method 400 may, for example, be performed by or on behalf of an insurer, a receivable account professional, and/or another type of user. It should be noted that although some of the steps of method 400 may be described herein as being performed by a client computer, while other steps are described herein as being performed by another computing device, any and all of the steps may be performed by a single computing device, which may be a client computer, server computer, third party data device or another computing device. Further, any steps described herein as being performed by a particular computing device may be performed by a human or another computing device as appropriate.

According to some embodiments, the method 400 may comprise determining a plurality of complexity survey questions, at 402. Such questions may be determined by receivable account personal, stored in and retrieved from, for example, workflow management data 296, for use by operations management system 160 in executing account complexity assessment instructions 212-2.

According to some embodiments, the method 400 may comprise presenting the plurality of complexity questions via a user interface for an account, at 404. In some embodiments, the user interface may comprise an interface as depicted in FIG. 6. FIG. 6 illustrates an example interface through which a user (e.g., a receivable account professional), computer, and/or application may determine one or more complexity ratings 630 for a given account 606.

The menu bar 602 provides access to various functions available in the operations management system 160. The navigation bar 604 provides user access to a hierarchy of information related to a receivable account. In particular, a user may enter, change, receive and/or transmit information about a receivable account, such as one or more of account name 606, unique account SAI code 608, current plan year 610, billing status 612, business unit 614, and region 616. The example interface also depicts completed date field 638, completed by field 640, updated date field 642 and updated by field 644, for displaying and/or editing information related to when a survey was completed and/or updated.

According to some embodiments, a complexity survey form may include respective item descriptions 618 for each question 624. Also, as depicted in FIG. 6 and in accordance with some embodiments, different responses may be allowed and/or required for a plurality of categories of account information, even for the same item description 618. As depicted, questions 624 may be directed to paid losses 620 and valuations 622 experiences with the receivable account, and the user is able to provide corresponding answers via the corresponding fields 626 for paid losses invoicing and fields 628 for valuations invoicing. Such data may include, without limitation, indicia that the receivable account may require more time to manage and/or may involve one or more manual processes, including indications of one or more of:

whether the billing for the account is for a group or organization,

whether there are foreign losses associated with the account,

whether the insurance account is associated with an investment credit program,

whether the insurance account is associated with a managed care program,

whether the insurance account is associated with a charge that is not applied automatically,

whether the insurance account is associated with a report that is not produced automatically,

whether the insurance account is associated with an invoice that is not produced automatically,

whether the insurance account is associated with multiple binders,

whether the insurance account is associated with open inventory,

whether the insurance account is associated with per claim charges,

whether the insurance account is associated with converted plan data,

whether the insurance account is associated with plan data invoicing,

whether the insurance account is associated with cash collateral,

whether the insurance account is associated with a special loss report, and

whether the insurance account is associated with manual spreadback.

In some arrangements, an insured and/or the insurer may spread insurance among different insurance companies, such as through co-insurance or reinsurance arrangements. In some circumstances, a receivable account professional may have to determine manually paid loss and/or valuation information for an account having these more complicated insurance arrangements, such as co-insurance and reinsurance situations, where the insurance is spread among different insurers.

Returning again to FIG. 4, some embodiments of the method 400 provide for receiving respective answers to the plurality of complexity survey questions, at 406. As indicated in FIG. 6, in some embodiments answers may be received (e.g., by an operations management system 160) via a user interface, such as by corresponding comboboxes 626 and 268 for answering the questions 624. Other embodiments may allow for receiving answers via various well known ways, such as by other types of interfaces and/or input devices 206.

Some embodiments of the method 400 provide for determining at least one complexity rating associated with the account based on the received answers, at 408. Various manners of determining a complexity rating, including a complexity rating indicating the relative complexity of billing for an account receivable, are discussed in this disclosure, for example with respect to account complexity assessment instructions 212-2. The example interface of FIG. 6 further provides for a save button 652 to save any changes made to the survey or other information, and a cancel button 650 to cancel any such changes. According to some embodiments, pressing save button 652 (or otherwise initiating the complexity rating analysis via a user interface) may result in the system determining overall account complexity rating 632, paid losses complexity rating 634, and valuations complexity rating 636 based on the information submitted and/or verified by the user.

Some embodiments of the method 400 provide for assigning the account to a user (e.g., a receivable account professional) based on the at least one complexity rating for the account. As discussed in this disclosure, in some embodiments, one or more actions may be determined, transmitted, and/or undertaken based on a determined complexity rating. For example, based on information about one or more users (e.g., from contact data 294), a relative measure of experience of each user may be determined and used, for instance, in determining an efficient assignment of receivable accounts based on account complexity and user experience. In this way, more complex cases may be assigned to more experienced users, and/or users may receive an appropriate workload balance of less and more complex accounts based on their relative experience levels. In one embodiment, the system generates a notification (e.g., to a receivable account professional or supervisor), if, for example, it is determined that a user has too many complex cases and the account inventory as a whole is not being allocated as efficiently as it could.

Referring now to FIG. 5, a flow diagram of a method 500 according to some embodiments is shown. The method 500 may be used, for example, in order to determine a billing priority rating for one or more receivable accounts. It should be noted that although some of the steps of method 500 may be described herein as being performed by a server computer, while other steps are described herein as being performed by another computing device, any and all of the steps may be performed by a single computing device which may be a client computer, server computer, third party data device or another computing device. Further, any steps described herein as being performed by a particular computing device may be performed by a human or another computing device as appropriate.

In some embodiments method 500 may comprise determining an invoice amount for an account, at 502. As discussed above with respect to billing priority assessment instructions 212-3, determining an invoice amount may comprise identifying one or more invoices (paid loss, valuation, or otherwise) billed during a previous time period (e.g., the preceding six months).

In some embodiments method 500 may comprise determining a complexity rating for the account, at 504, as discussed above with respect to methods 300 and 400. Method 500 may further comprise determining a billing priority rating based on the invoice amount and the complexity rating. As discussed above with respect to billing priority assessment instructions 212-3, determining the billing priority rating may comprise determining an average invoice amount (based on one or more invoices during a defined time period). In this way the system may determine an indication of the revenue value of an account. In some embodiments, determining the billing priority rating may comprise looking up in a database, calculating, or otherwise identifying a rating based on both the invoice amount (e.g., as may be reflected in an average invoice amount) and the complexity rating. The determined billing priority rating may be stored, for example, in account data 292 and/or workflow management data 296, and/or may be displayed, presented or otherwise transmitted to one or more users (e.g., via a user interface) for use in prioritizing workflow tasks.

Although certain types of information are illustrated in the example interface of FIG. 6, those skilled in the art will understand that the interface may be modified in order to provide for additional types of and/or to remove some of the illustrated types of information, as deemed desirable for a particular implementation.

Those skilled in the art will readily understand, in light of the present disclosure, that the features and information described with respect to the interface of FIG. 6, including the indicated form fields, or a subset of such features and information, may be included in a single interface, screen display or application window, or may be presented using multiple such interfaces, displays or windows. For example, a single interface window may be used for inputting relevant claim information and displaying determined recidivism scores and recommended procedures on the same screen, tab or page of the interface.

Some embodiments described in this application provide for systems, methods, apparatus and articles of manufacture to create a consolidated environment, for example, to manage accounts and to improve operational efficiency, operational agility, and/or data quality. Such systems and methods, can for example, reduce risk, improve agility through technology, and reduce the number of systems and/or applications in the environment.

Enterprise Billing and Receivables (EBAR) is an example of an application, consistent with some embodiments disclosed, designed to be a comprehensive user interface for businesses and business units directed to receivable account managements. In some embodiments, EBAR specifically serves Loss Sensitive Receivable Account Management, for example, to maintain an inventory of accounts and related information and to manage progress and completion of current work related to loss sensitive insurance plans. In some embodiments, the EBAR system contains all account information for the loss sensitive accounts. Detailed information for each account along with numerous production reports by Business Unit, Region, Bill Types, Valuation Dates, etc. and work in progress views may be made available within the EBAR application. In some embodiments, one or more other reporting systems may be optionally available within the reporting environment to produce ad hoc reports based on the EBAR system data.

Some embodiments enable multiple functions to be performed in a single environment. Process workflow is substantially improved, making the work more efficient. Financial and audit related controls are also substantially improved. Staff members may be allowed to complete work more efficiently and effectively, and managers may improve their ability to manage work product more efficiently and effectively. Substantial improvement may be provided to the availability and ease of obtaining management information, for example that associated with loss sensitive billing collections. Work may automatically assigned, tracked in EBAR as functions are completed and financially controlled in a much more efficient and effective manner. In accordance with some embodiments, therefore, an environment for handling loss sensitive accounts is created that allows increased availability of data and management information, allowing users to manage and provide information more timely and effectively.

Some embodiments includes web-based products and/or services, which create an environment where work is integrated and assigned to staff members automatically and the staff members can obtain their work list by just entering the EBAR application. Data structure may be developed such that staff can easily obtain, track, and complete work and such that information can be rolled up to manager level to review work, assign work, and assess workloads in a very efficient manner. Work may be automatically fed into the example EBAR application, assigned to applicable staff members, tracked and managed through the database, and operationally and financially controlled within the database. EBAR enhances the quality and the application may be improved from an audit and financial control perspective.

In some embodiments of the invention, the environment includes all billing and collection functions in a single environment, whereas alternative embodiments may break out the responsibilities functionally (e.g., Billing Unit/Collection Unit/Cash Unit). A single environment may allow billing and collection functions as well as underwriting, account executives and managers, credit risk management, financial integrity (or finance), and/or receivable management cash support, and/or other marketing partners in the process to have a single point of contact, which may provide a competitive advantage in some instances. In addition, in some embodiments EBAR may be implemented as a comprehensive billing environment for an enterprise that includes Loss Sensitive, Direct Bill and Agency Bill, whereas in alternative embodiments, such work may be completed in segregated environments.

In some embodiments, the EBAR application utilizes four categories of information: account management, contact management, work management and operational and ad hoc reporting. The account management function captures all information relating to an account including its billing parameters, plan years, and financial information. The application also includes a transactional history for modifications made to an account and to an invoice.

In some embodiments the EBAR application also acts as a centralized repository for account contacts including, for example, customer contacts, receivable accounts management employees, and other internal contacts associated with an account. Receivable account management contacts can easily be updated based, for example, on role and permissions. These contacts can also be optionally sorted by team.

EBAR, in some embodiments, may also provide enhancements to work management processes, for example, through the automation of work lists. In some embodiments, work assignments may be customized for each receivable account manager (RAM), and may be presented to each individual, for example, as a personalized dashboard within the system. The application also features the optional ability to associate comments with actions, which assists with internal communication.

In some embodiments, reporting features allow receivable account management personnel the ability to view a complete summary of the data organized by the application. The reports, for example, may offer a comprehensive audit trail and allow management to better manage workloads and balancing. The reporting environment also allows for the creation of reports on an ad hoc basis.

Referring now to FIG. 7, a flow diagram of a method 700 according to some embodiments is shown. The method 700 represents a process workflow related to a loss sensitive insurance business environment. It should be noted that although some of the steps of method 700 may be described herein as being performed by a server computer and/or EBAR application, while other steps are described herein as being performed by another computing device, any and all of the steps may be performed by a single computing device which may be a client computer, server computer, third party data device or another computing device. Further, any steps described herein as being performed by a particular computing device may be performed by a human or another computing device as appropriate.

In some embodiments method 700 may comprise completion of a pre-renewal for an existing loss sensitive insurance account, at 702. In one embodiment, a pre-renewal form or checklist is completed and submitted, for example, to a marketer (e.g., associated with an established account). At 704, the account is established (if a new account) and/or updated (e.g., if an existing or renewing account). This may comprise, for example, receiving a sold deal notification and/or billing document. Account information that may be established or updated may include, for example, an account status (e.g., new, renewal, etc.), agreement term(s) (e.g., dates of coverage, invoice dates), and/or internal and/or external contact information.

At 706 the deal is documented, for example, by retrieving (e.g., automatically) an agreement letter associated with the deal/account. Billing parameters for the account are established, at 708. This may include, for example, one or more quality reviews/approvals, establishing payor information, and/or determining one or more complexity ratings for the account. At 710, installments are generated. This may include one or more of: entering and reviewing installment schedules, generating installment bill items, generating one or more installment invoices, and/or one or more quality reviews/approvals.

At 712 paid losses are generated, which may include one or more of: updating manual charges to the account, calculating paid losses for the account, balancing losses, generating paid loss bill items, one or more quality review/approvals, generating one or more paid loss invoices, and/or establishing monthly cash collateral. At 714 guaranteed cost audits are generated. This may include receiving guaranteed cost audit documents, entering and/or calculating guaranteed cost audit information, generating guaranteed cost bill items, one or more quality review/approvals, and generating one or more guaranteed cost audit invoices. At 716 valuations are generated, which may include one or more of: entering audited exposures, updating manual charges to the account, calculating valuations for the account, balancing losses, generating valuation bill items, one or more quality review/approvals, generating one or more valuation invoices, and/or establishing valuation cash collateral.

The account may be serviced, as represented at 718, by performing one or more of: revising and/or cancelling tracked invoices, servicing calls (e.g., discussing invoices with brokers and/or insureds), researching account issues, addressing billing discrepancies, managing contacts for the account, and/or calculation collateral. At 720, overdue invoices are managed, such as by invoking an escalation process (e.g., to notify and follow up with late payers), research account issues, and/or identify chronic late payers and/or identify “hot list” accounts (e.g., with prioritized issues). At 722, payment is received; at 724, the receivable is managed, for example, by one or more of: generating waivers/deferrals, handling disbursements, addressing unapplied suspense tracking, applying payment, unpaying invoices (e.g., to address an error), and/or determining and/or applying commission.

At 726, sub-ledger transactions may be performed, such as transactional balancing, transmitting related information to the general ledger system, and/or financial analysis (e.g., booked vs. billed vs. paid). Reporting may be performed, as represented at 728, such as by providing operational overview reports, reports for management, and/or user defined ad hoc reporting.

Throughout the description and unless otherwise specified, the following terms may include and/or encompass the example meanings provided below. These terms and illustrative example meanings are provided to clarify the language selected to describe embodiments both in the specification and in the appended claims, and accordingly, are not intended to be limiting.

Numerous embodiments are described in this disclosure, and are presented for illustrative purposes only. The described embodiments are not, and are not intended to be, limiting in any sense. The presently disclosed invention(s) are widely applicable to numerous embodiments, as is readily apparent from the disclosure. One of ordinary skill in the art will recognize that the disclosed invention(s) may be practiced with various modifications and alterations, such as structural, logical, software, and electrical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

The present disclosure is neither a literal description of all embodiments nor a listing of features of the invention that must be present in all embodiments.

Neither the Title (set forth at the beginning of the first page of this disclosure) nor the Abstract (set forth at the end of this disclosure) is to be taken as limiting in any way as the scope of the disclosed invention(s).

The phrase “based on” does not mean “based only on”, unless expressly specified otherwise. In other words, the phrase “based on” describes both “based only on” and “based at least on”.

When a single device or article is described herein, more than one device or article (whether or not they cooperate) may alternatively be used in place of the single device or article that is described. Accordingly, the functionality that is described as being possessed by a device may alternatively be possessed by more than one device or article (whether or not they cooperate).

Similarly, where more than one device or article is described herein (whether or not they cooperate), a single device or article may alternatively be used in place of the more than one device or article that is described. For example, a plurality of computer-based devices may be substituted with a single computer-based device. Accordingly, the various functionality that is described as being possessed by more than one device or article may alternatively be possessed by a single device or article.

The functionality and/or the features of a single device that is described may be alternatively embodied by one or more other devices that are described but are not explicitly described as having such functionality and/or features. Thus, other embodiments need not include the described device itself, but rather can include the one or more other devices which would, in those other embodiments, have such functionality/features.

Devices that are in communication with each other need not be in continuous communication with each other, unless expressly specified otherwise. On the contrary, such devices need only transmit to each other as necessary or desirable, and may actually refrain from exchanging data most of the time. For example, a machine in communication with another machine via the Internet may not transmit data to the other machine for weeks at a time. In addition, devices that are in communication with each other may communicate directly or indirectly through one or more intermediaries.

A description of an embodiment with several components or features does not imply that all or even any of such components and/or features are required. On the contrary, a variety of optional components are described to illustrate the wide variety of possible embodiments of the present invention(s). Unless otherwise specified explicitly, no component and/or feature is essential or required.

Further, although process steps, algorithms or the like may be described in a sequential order, such processes may be configured to work in different orders. In other words, any sequence or order of steps that may be explicitly described does not necessarily indicate a requirement that the steps be performed in that order. The steps of processes described herein may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to the invention, and does not imply that the illustrated process is preferred.

“Determining” something can be performed in a variety of manners and therefore the term “determining” (and like terms) includes calculating, computing, deriving, looking up (e.g., in a table, database or data structure), ascertaining, recognizing, and the like.

A “display” as that term is used herein is an area that conveys information to a viewer. The information may be dynamic, in which case, an LCD, LED, CRT, Digital Light Processing (DLP), rear projection, front projection, or the like may be used to form the display. The aspect ratio of the display may be 4:3, 16:9, or the like. Furthermore, the resolution of the display may be any appropriate resolution such as 480i, 480p, 720p, 1080i, 1080p or the like. The format of information sent to the display may be any appropriate format such as Standard Definition Television (SDTV), Enhanced Definition TV (EDTV), High Definition TV (HDTV), or the like. The information may likewise be static, in which case, painted glass may be used to form the display. Note that static information may be presented on a display capable of displaying dynamic information if desired. Some displays may be interactive and may include touch screen features or associated keypads as is well understood.

The present disclosure may refer to a “control system”. A control system, as that term is used herein, may be a computer processor coupled with an operating system, device drivers, and appropriate programs (collectively “software”) with instructions to provide the functionality described for the control system. The software is stored in an associated memory device (sometimes referred to as a computer readable medium). While it is contemplated that an appropriately programmed general purpose computer or computing device may be used, it is also contemplated that hard-wired circuitry or custom hardware (e.g., an application specific integrated circuit (ASIC)) may be used in place of, or in combination with, software instructions for implementation of the processes of various embodiments. Thus, embodiments are not limited to any specific combination of hardware and software.

A “processor” means any one or more microprocessors, Central Processing Unit (CPU) devices, computing devices, microcontrollers, digital signal processors, or like devices. Exemplary processors are the INTEL PENTIUM or AMD ATHLON processors.

As used herein, the term “network component” may refer to a user or network device, or a component, piece, portion, or combination of user or network devices. Examples of network components may include a Static Random Access Memory (SRAM) device or module, a network processor, and a network communication path, connection, port, or cable.

In addition, some embodiments are associated with a “network” or a “communication network”. As used herein, the terms “network” and “communication network” may be used interchangeably and may refer to any object, entity, component, device, and/or any combination thereof that permits, facilitates, and/or otherwise contributes to or is associated with the transmission of messages, packets, signals, and/or other forms of information between and/or within one or more network devices. Networks may be or include a plurality of interconnected network devices. In some embodiments, networks may be hard-wired, wireless, virtual, neural, and/or any other configuration of type that is or becomes known. Communication networks may include, for example, one or more networks configured to operate in accordance with the Fast Ethernet LAN transmission standard 802.3-2002® published by the Institute of Electrical and Electronics Engineers (IEEE). In some embodiments, a network may include one or more wired and/or wireless networks operated in accordance with any communication standard or protocol that is or becomes known or practicable.

As used herein, the terms “information” and “data” may be used interchangeably and may refer to any data, text, voice, video, image, message, bit, packet, pulse, tone, waveform, and/or other type or configuration of signal and/or information. Information may comprise information packets transmitted, for example, in accordance with the Internet Protocol Version 6 (IPv6) standard as defined by “Internet Protocol Version 6 (IPv6) Specification” RFC 1883, published by the Internet Engineering Task Force (IETF), Network Working Group, S. Deering et al. (December 1995). Information may, according to some embodiments, be compressed, encoded, encrypted, and/or otherwise packaged or manipulated in accordance with any method that is or becomes known or practicable.

In addition, some embodiments described herein are associated with an “indication”. As used herein, the term “indication” may be used to refer to any indicia and/or other information indicative of or associated with a subject, item, entity, and/or other object and/or idea. As used herein, the phrases “information indicative of and “indicia” may be used to refer to any information that represents, describes, and/or is otherwise associated with a related entity, subject, or object. Indicia of information may include, for example, a code, a reference, a link, a signal, an identifier, and/or any combination thereof and/or any other informative representation associated with the information. In some embodiments, indicia of information (or indicative of the information) may be or include the information itself and/or any portion or component of the information. In some embodiments, an indication may include a request, a solicitation, a broadcast, and/or any other form of information gathering and/or dissemination.

The term “computer-readable medium” refers to any statutory medium that participates in providing data (e.g., instructions) that may be read by a computer, a processor or a like device. Such a medium may take many forms, including but not limited to non-volatile media, volatile media, and specific statutory types of transmission media. Non-volatile media include, for example, optical or magnetic disks and other persistent memory. Volatile media include DRAM, which typically constitutes the main memory. Statutory types of transmission media include coaxial cables, copper wire and fiber optics, including the wires that comprise a system bus coupled to the processor. Common forms of computer-readable media include, for example, a floppy disk, a flexible disk, hard disk, magnetic tape, any other magnetic medium, a CD-ROM, Digital Video Disc (DVD), any other optical medium, punch cards, paper tape, any other physical medium with patterns of holes, a RAM, a PROM, an EPROM, a FLASH-EEPROM, a USB memory stick, a dongle, any other memory chip or cartridge, a carrier wave, or any other medium from which a computer can read. The terms “computer-readable memory” and/or “tangible media” specifically exclude signals, waves, and wave forms or other intangible or transitory media that may nevertheless be readable by a computer.

Various forms of computer readable media may be involved in carrying sequences of instructions to a processor. For example, sequences of instruction (i) may be delivered from RAM to a processor, (ii) may be carried over a wireless transmission medium, and/or (iii) may be formatted according to numerous formats, standards or protocols. For a more exhaustive list of protocols, the term “network” is defined below and includes many exemplary protocols that are also applicable here.

It will be readily apparent that the various methods and algorithms described herein may be implemented by a control system and/or the instructions of the software may be designed to carry out the processes of the present invention.

Where databases are described, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats (including relational databases, object-based models, hierarchical electronic file structures, and/or distributed databases) could be used to store and manipulate the data types described herein. Likewise, object methods or behaviors of a database can be used to implement various processes, such as those described herein. In addition, the databases may, in a known manner, be stored locally or remotely from a device that accesses data in such a database. Furthermore, while unified databases may be contemplated, it is also possible that the databases may be distributed and/or duplicated amongst a variety of devices.

As used herein, the term “network component” may refer to a user or network device, or a component, piece, portion, or combination of user or network devices. Examples of network components may include a Static Random Access Memory (SRAM) device or module, a network processor, and a network communication path, connection, port, or cable.

As used herein, the terms “information” and “data” may be used interchangeably and may refer to any data, text, voice, video, image, message, bit, packet, pulse, tone, waveform, and/or other type or configuration of signal and/or information. Information may comprise information packets transmitted, for example, in accordance with the Internet Protocol Version 6 (IPv6) standard as defined by “Internet Protocol Version 6 (IPv6) Specification” RFC 1883, published by the Internet Engineering Task Force (IETF), Network Working Group, S. Deering et al. (December 1995). Information may, according to some embodiments, be compressed, encoded, encrypted, and/or otherwise packaged or manipulated in accordance with any method that is or becomes known or practicable.

In addition, some embodiments described herein are associated with an “indication”. As used herein, the term “indication” may be used to refer to any indicia and/or other information indicative of or associated with a subject, item, entity, and/or other object and/or idea. As used herein, the phrases “information indicative of and “indicia” may be used to refer to any information that represents, describes, and/or is otherwise associated with a related entity, subject, or object. Indicia of information may include, for example, a code, a reference, a link, a signal, an identifier, and/or any combination thereof and/or any other informative representation associated with the information. In some embodiments, indicia of information (or indicative of the information) may be or include the information itself and/or any portion or component of the information. In some embodiments, an indication may include a request, a solicitation, a broadcast, and/or any other form of information gathering and/or dissemination.

In addition, some embodiments are associated with a “network” or a “communication network”. As used herein, the terms “network” and “communication network” may be used interchangeably and may refer to an environment wherein one or more computing devices may communicate with one another, and/or to any object, entity, component, device, and/or any combination thereof that permits, facilitates, and/or otherwise contributes to or is associated with the transmission of messages, packets, signals, and/or other forms of information between and/or within one or more network devices. Such devices may communicate directly or indirectly, via a wired or wireless medium such as the Internet, LAN, WAN or Ethernet (or IEEE 802.3), Token Ring, or via any appropriate communications means or combination of communications means. In some embodiments, a network may include one or more wired and/or wireless networks operated in accordance with any communication standard or protocol that is or becomes known or practicable. Exemplary protocols include but are not limited to: Bluetooth™, Time Division Multiple Access (TDMA), Code Division Multiple Access (CDMA), Global System for Mobile communications (GSM), Enhanced Data rates for GSM Evolution (EDGE), General Packet Radio Service (GPRS), Wideband CDMA (WCDMA), Advanced Mobile Phone System (AMPS), Digital AMPS (D-AMPS), IEEE 802.11 (WI-FI), IEEE 802.3, SAP, the best of breed (BOB), system to system (S2S), the Fast Ethernet LAN transmission standard 802.3-2002® published by the Institute of Electrical and Electronics Engineers (IEEE), or the like. Networks may be or include a plurality of interconnected network devices. In some embodiments, networks may be hard-wired, wireless, virtual, neural, and/or any other configuration of type that is or becomes known. Note that if video signals or large files are being sent over the network, a broadband network may be used to alleviate delays associated with the transfer of such large files, however, such is not strictly required. Each of the devices is adapted to communicate on such a communication means. Any number and type of machines may be in communication via the network. Where the network is the Internet, communications over the Internet may be through a website maintained by a computer on a remote server or over an online data network including commercial online service providers, bulletin board systems, and the like. In yet other embodiments, the devices may communicate with one another over RF, cable TV, satellite links, and the like. Where appropriate encryption or other security measures such as logins and passwords may be provided to protect proprietary or confidential information.

Communication among computers and devices may be encrypted to insure privacy and prevent fraud in any of a variety of ways well known in the art. Appropriate cryptographic protocols for bolstering system security are described in Schneier, APPLIED CRYPTOGRAPHY, PROTOCOLS, ALGORITHMS, AND SOURCE CODE IN C, John Wiley & Sons, Inc. 2d ed., 1996, which is incorporated by reference in its entirety.

It will be readily apparent that the various methods and algorithms described herein may be implemented by, e.g., appropriately programmed general purpose computers and computing devices. Typically a processor (e.g., one or more microprocessors) will receive instructions from a memory or like device, and execute those instructions, thereby performing one or more processes defined by those instructions. Further, programs that implement such methods and algorithms may be stored and transmitted using a variety of media (e.g., computer readable media) in a number of manners. In some embodiments, hard-wired circuitry or custom hardware may be used in place of, or in combination with, software instructions for implementation of the processes of various embodiments. Thus, embodiments are not limited to any specific combination of hardware and software. Accordingly, a description of a process likewise describes at least one apparatus for performing the process, and likewise describes at least one computer-readable medium and/or memory for performing the process. The apparatus that performs the process can include components and devices (e.g., a processor, input and output devices) appropriate to perform the process. A computer-readable medium can store program elements appropriate to perform the method.

The present disclosure provides, to one of ordinary skill in the art, an enabling description of several embodiments and/or inventions. Some of these embodiments and/or inventions may not be claimed in the present application, but may nevertheless be claimed in one or more continuing applications that claim the benefit of priority of the present application. Applicants intend to file additional applications to pursue patents for subject matter that has been disclosed and enabled but not claimed in the present application.

The described embodiments are not limited to the details of construction and/or to the arrangements of the components set forth in this disclosure or illustrated in the drawings. Other embodiments may be practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. This disclosure, therefore, must be regarded as including constructions equivalent to those described. For example, the specific sequence of the described process may be altered so that certain processes are conducted in parallel or independent, with other processes, to the extent that the processes are not dependent upon each other. Thus, the specific order of steps described herein is not to be considered implying a specific sequence of steps to perform the process. In alternative embodiments, one or more process steps may be implemented by a user-assisted process and/or manually. Other alterations or modifications of the above processes are also contemplated. For example, further insubstantial approximations of the process and/or algorithms are also considered within the scope of the processes described herein.

In addition, features illustrated or described as part of one embodiment can be used on other embodiments to yield a still further embodiment. Additionally, certain features may be interchanged with similar devices or features not mentioned yet which perform the same or similar functions. It is therefore intended that such modifications and variations are included within the totality of the inventive matter disclosed.

1. An apparatus comprising:
a processor;
a user interface in communication with the processor; and
a computer-readable memory in communication with the processor, the computer-readable memory storing instructions that when executed by the processor result in:
determining billing information for an insurance account, the billing information comprising at least one of: (i) paid loss information for the insurance account and (ii) valuation information for the insurance account;
determining at least one rule for determining billing complexity for the insurance account;
determining an indication of billing complexity for the insurance account based on the at least one rule for determining billing complexity and based on at least one of: (i) the paid loss information for the insurance account and (ii) the valuation information for the insurance account; and
transmitting, via the user interface, an indication of the billing complexity for the insurance account.

2. The apparatus of claim 1, wherein determining the indication of billing complexity for the insurance account comprises:
generating an overall complexity rating for the insurance account.

3. The apparatus of claim 1, wherein determining the indication of billing complexity for the insurance account comprises:
generating an indication of the complexity of paid loss invoicing for the insurance account.

4. The apparatus of claim 1, wherein determining the indication of billing complexity for the insurance account comprises:
generating an indication of the complexity of valuation invoicing for the insurance account.

5. The apparatus of claim 1, wherein determining the billing information comprises:
determining at least one of:
whether the billing is for a group or organization,
whether there were foreign losses,
whether the insurance account is associated with an investment credit program,
whether the insurance account is associated with a managed care program,
whether the insurance account is associated with a charge that is not applied automatically,
whether the insurance account is associated with a report that is not produced automatically,
whether the insurance account is associated with an invoice that is not produced automatically,
whether the insurance account is associated with multiple binders,
whether the insurance account is associated with open inventory,
whether the insurance account is associated with per claim charges,
whether the insurance account is associated with converted plan data,
whether the insurance account is associated with plan data invoicing,
whether the insurance account is associated with cash collateral,
whether the insurance account is associated with a special loss report, and
whether the insurance account is associated with manual spreadback.

6. The apparatus of claim 1, wherein determining the billing information comprises:
determining at least one survey question;
presenting the at least one survey question to a user via the user interface; and
receiving a respective answer to at least one of the at least one survey questions.

7. The apparatus of claim 1, wherein determining the indication of billing complexity for the insurance account comprises:
determining a count of like answers to a complexity survey; and
determining the indication of billing complexity for the insurance account based on the count of like answers and the at least one rule for determining billing complexity for the insurance account.

8. The apparatus of claim 7, wherein determining the indication of billing complexity for the insurance account comprises:
determining that the count of like answers is within a predetermined count range; and
selecting an indication of billing complexity that is associated with the predetermined count range.

9. The apparatus of claim 1, wherein determining the indication of billing complexity for the insurance account comprises:
determining an answer to one of a plurality of questions in a complexity survey; and
selecting a predetermined indication of billing complexity that is associated with the determined answer, irrespective of any other answers to the complexity survey.

10. The apparatus of claim 1, the computer-readable memory storing instructions that when executed by the processor further result in:
determining a user to whom to assign the insurance account based on the indication of billing complexity; and
storing an indication that the user is assigned to the insurance account.

11. The apparatus of claim 1, the computer-readable memory storing instructions that when executed by the processor further result in:
determining a billing priority rating based on the indication of billing complexity; and
storing an indication of the billing priority rating in association with the insurance account.

12. A computer readable memory storing instructions that when executed by a computer comprising at least one processor result in:
determining, by the computer, billing information for an insurance account, the billing information comprising at least one of: (i) paid loss information for the insurance account and (ii) valuation information for the insurance account;
determining, by the computer, at least one rule for determining billing complexity for the insurance account;
determining, by the computer, an indication of billing complexity for the insurance account based on the at least one rule for determining billing complexity and based on at least one of: (i) the paid loss information for the insurance account and (ii) the valuation information for the insurance account; and transmitting, by the computer via a user interface, an indication of the billing complexity for the insurance account.

13. A method comprising:
determining, by a specially-programmed computerized processing device, billing information for an insurance account, the billing information comprising at least one of: (i) paid loss information for the insurance account and (ii) valuation information for the insurance account;
determining, by the specially-programmed computerized processing device, at least one rule for determining billing complexity for the insurance account;
determining, by the specially-programmed computerized processing device, an indication of billing complexity for the insurance account based on the at least one rule for determining billing complexity and based on at least one of: (i) the paid loss information for the insurance account and (ii) the valuation information for the insurance account; and
transmitting, by the specially-programmed computerized processing device via a user interface, an indication of the billing complexity for the insurance account.

14. The method of claim 13, wherein determining the indication of billing complexity for the insurance account comprises:
generating an overall complexity rating for the insurance account.

15. The method of claim 13, wherein determining the indication of billing complexity the insurance account comprises:
generating an indication of the complexity of paid loss invoicing for the insurance account.

16. The method of claim 13, wherein determining the indication of billing complexity for the insurance account comprises:
generating an indication of the complexity of valuation invoicing for the insurance account.

17. The method of claim 13, wherein determining the billing information comprises:
determining at least one of:
whether the billing is for a group or organization,
whether there were foreign losses,
whether the insurance account is associated with an investment credit program,
whether the insurance account is associated with a managed care program,
whether the insurance account is associated with a charge that is not applied automatically,
whether the insurance account is associated with a report that is not produced automatically,
whether the insurance account is associated with an invoice that is not produced automatically,
whether the insurance account is associated with multiple binders,
whether the insurance account is associated with open inventory,
whether the insurance account is associated with per claim charges,
whether the insurance account is associated with converted plan data,
whether the insurance account is associated with plan data invoicing,
whether the insurance account is associated with cash collateral,
whether the insurance account is associated with a special loss report, and
whether the insurance account is associated with manual spreadback.

18. The method of claim 13, wherein determining the billing information comprises:
determining at least one survey question;
presenting the at least one survey question to a user via the user interface; and
receiving a respective answer to at least one of the at least one survey questions.

19. The method of claim 13, wherein determining the indication of billing complexity for the insurance account comprises:
determining a count of like answers to a complexity survey; and
determining the indication of billing complexity for the insurance account based on the count of like answers and the at least one rule for determining billing complexity for the insurance account.

20. The apparatus of claim 19, wherein determining the indication of billing complexity for the insurance account comprises:
determining that the count of like answers is within a predetermined count range; and
selecting an indication of billing complexity that is associated with the predetermined count range.

21. The method of claim 13, wherein determining the indication of billing complexity for the insurance account comprises:
determining an answer to one of a plurality of questions in a complexity survey; and
selecting a predetermined indication of billing complexity that is associated with the determined answer, irrespective of any other answers to the complexity survey.

22. The method of claim 13, further comprising:
determining, by the specially-programmed computerized processing device, a user to whom to assign the insurance account based on the indication of billing complexity; and
storing, by the specially-programmed computerized processing device, an indication that the user is assigned to the insurance account.

23. The method of claim 13, further comprising:
determining, by the specially-programmed computerized processing device, a billing priority rating based on the indication of billing complexity; and
storing, by the specially-programmed computerized processing device, an indication of the billing priority rating in association with the insurance account.

24. A method comprising:
determining, by a specially-programmed computerized processing device, account data relating to a loss sensitive insurance account;
determining, by the specially-programmed computerized processing device, a complexity rating for the loss sensitive insurance account based on the account data;
determining, by the specially-programmed computerized processing device, a billing priority rating for the loss sensitive insurance account based on the determined complexity rating; and
storing, by the specially-programmed computerized processing device, an indication of the billing priority rating in association with the loss sensitive insurance account.

25. A method comprising:
determining, by a specially-programmed computerized processing device, account data relating to a loss sensitive insurance account;
determining, by the specially-programmed computerized processing device, a complexity rating for the loss sensitive insurance account based on the account data;
determining, by the specially-programmed computerized processing device, the loss sensitive insurance account is to be assigned to a user based on the determined complexity rating; and
storing, by the specially-programmed computerized processing device, an indication that the loss sensitive insurance account is assigned to the user.
